(19) United States
(12) Patent Application Publication
(10) Pub. No.: US 2007/0218229 A1
(43) Pub. Date: Sep. 20, 2007

(54) Composite container for adhesive

(75) Inventors: Yoshio Nagahama, Kobe-shi (JP); Eizo Kajigaki, Takatsuki-shi (JP)

Correspondence Address: NIXON & VANDERHYE, PC, 901 NORTH GLEBE ROAD, 11TH FLOOR, ARLINGTON, VA, 22203, US

(73) Assignee: Taoka Chemical Co., Ltd., Osaka (JP)

(21) Appl. No.: 11/717,086

(22) Filed: Mar. 13, 2007

(30) Foreign Application Priority Data
Mar. 17, 2006 (JP) 2006-75289

(51) Int. Cl. B32B 27/08

(52) U.S. Cl. 428/35.7; 428/34.1

(57) ABSTRACT

According to the present invention, a composite container for an adhesive includes: an aluminum container which contains an adhesive; and a resin outer container for holding the aluminum container, the resin outer container being provided with (a) window holes on both side wall surfaces of the resin outer container and (b) two press sections for indirectly pressing the aluminum container through the window holes, each of the press sections being provided with a deformable plate-like spring whose one end is fixed to an upper end of the press section which upper end is in contact with the aluminum container.

This Nonprovisional application claims priority under 35 U.S.C. § 119(a) on Patent Application No. 75289/2006 filed in Japan on Mar. 17, 2006, the entire contents of which are hereby incorporated by reference.

### FIELD OF THE INVENTION

The present invention relates to a composite container for an adhesive.

### BACKGROUND OF THE INVENTION

A conventionally known composite container for an adhesive is composed of an aluminum container containing an adhesive and a resin outer container holding the aluminum container.

The conventional composite container for an adhesive has a problem in that there is difficulty in precisely controlling a discharging amount of the adhesive, which causes difficulty in using the adhesive in the aluminum container at a constant amount. The conventional composite container for an adhesive also has a problem in that a part of the adhesive in the aluminum container cannot be discharged and remained in the aluminum container. Accordingly, there have been demands for solution of these problems.

In response to these demands, the inventors of the present invention have previously proposed (I) a composite container for an adhesive which container has a window hole on one side wall of a resin outer container so that the aluminum container held by the resin outer container can be directly pressed with a finger (Japanese Unexamined Patent Publication No. 20078/2003 (Tokukai 2003-20078 (published on Jan. 21, 2003)), (II) a composite container for an adhesive which container has a deformable notch on one side wall of a resin outer container so that an aluminum container held by the resin outer container is indirectly pressed with a finger (Japanese Unexamined Patent Publication No. 226374/2003 (Tokukai 2003-226374 (published on Aug. 12, 2003)), and (III) a composite container for an adhesive which container has a deformable press section on one side wall of a resin outer container so that an aluminum container held by the resin outer container is indirectly pressed with a finger (Japanese Unexamined Patent Publication No. 182249/2004 (Tokukai 2004-182249 (published on Jul. 2, 2004)). Compared with the composite container conventionally known prior to the composite containers proposed in (I), (II), and (III), the composite container proposed in (I) and (II) are more advantageous in that the composite container makes it possible to control a discharging amount of the adhesive and carry out separated disposal. However, the composite container proposed in (I) has problems in that (i) this composite container might be damaged by a fingernail and the like because it is necessary to press the aluminum container directly with a finger and (ii) precise control of the discharging amount of the adhesive is not sufficiently carried out. The composite container proposed in (II) has improvement in precise control of the discharging amount, compared with the composite container proposed in (I). However, when the composite container proposed in (II) contains an adhesive having a high viscosity, a part of the adhesive located close to an adhesive discharging section of the aluminum container tends to be undischarged and remain in the aluminum container. The composite container proposed in (III), as with the composite containers proposed in (I) and (II), makes it possible to control a discharging amount of the adhesive and carry out separated disposal. Moreover, compared with the composite containers proposed in (I) and (II), in the composite container proposed in (III), pressure due to a press with a finger can be better transmitted to a section located close to an adhesive discharging section of the aluminum container. Therefore, the composite container proposed in (III) is advantageous in reducing an amount of a residual adhesive in the container. However, with the use of the composite container proposed in (III), a discharging amount of the adhesive cannot be precisely controlled to a satisfactory level, and the amount of the residual adhesive in the container tends to become relatively large when the adhesive has a high viscosity.

Other examples of a composite container for an adhesive are the composite containers proposed in Japanese Design Registration No. 1096733 (registered on Nov. 2, 2000) and Japanese Design Registration No. 1096734 (registered on Nov. 2, 2000). Each of the composite containers of these examples includes an arrangement in which an aluminum container is pinched only by two plate-like sections respectively attached to press sections. This arrangement causes insufficient transmission of a pressure to the aluminum container in a part that is close to a tail section of the aluminum container. This results in a problem in that a part of the adhesive in the aluminum container cannot be discharged and remains in the aluminum container. Accordingly, there has been a demand for development of a composite container for an adhesive, which container can reduce, regardless of a viscosity of the adhesive, the amount of the adhesive undischarged and remaining in the aluminum container containing the adhesive.

### SUMMARY OF THE INVENTION

An object of the present invention is to provide a composite container for an adhesive, which container can precisely control an discharging amount of the adhesive and reduce an amount of the adhesive undischarged and remaining in the aluminum container containing the adhesive, regardless of a viscosity of the adhesive, and, moreover, to provide a composite container which can precisely control the discharging amount of the adhesive without any direct touch of a hand on the aluminum container containing the adhesive.

In order to achieve the above-mentioned object, a composite container for an adhesive, according to the present invention, includes: an aluminum container which contains an adhesive; and a resin outer container for holding the aluminum container, the resin outer container being provided with (a) window holes on both side wall surfaces of the resin outer container and (b) two press sections for indirectly pressing the aluminum container through the window holes, each of the press sections being provided with a deformable plate-like spring whose one end is fixed to an upper end of the press section which upper end is in contact with the aluminum container.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a perspective view of one specific embodiment of a composite container for an adhesive according to the present invention.

FIG. 2 is a plan view of a front side of the specific embodiment of the composite container for an adhesive according to the present invention.

FIG. 3 is a plan view of a back side of the specific embodiment of the composite container for an adhesive according to the present invention.

FIG. 4 is a perspective view of an inner surface of a resin main body case according to the present invention.

FIG. 5 is a perspective view of a side surface of the resin main body cover according to the present invention.

FIG. 6 is a perspective view of a press component including a two-stage plate-like spring structure according to the present invention.

FIG. 7 is a perspective view of a resin nozzle according to the present invention.

FIG. 8 is a perspective view of a resin cap according to the present invention.

FIG. 9 is a longitudinal sectional view illustrating an entire outer container according to the present invention.

### DESCRIPTION OF THE EMBODIMENTS

In order to solve the foregoing problems, the inventors of the present invention diligently researched on composite containers for adhesives having various kinds of shapes and mechanisms. As a result, the inventors accomplished the present invention by finding that it is possible to (i), regardless of viscosity of an adhesive, reduce an amount of the adhesive undischarged and remaining in the aluminum container containing the adhesive and (ii) precisely control a discharging amount of the adhesive with the use of a composite container for an adhesive including: an aluminum container which contains an adhesive; and a resin outer container for holding the aluminum container, the resin outer container being provided with (a) window holes on both side wall surfaces of the resin outer container and (b) two press sections for indirectly pressing the aluminum container through the window holes, each of the press sections being provided with a deformable plate-like spring whose one end is fixed to an upper end of the press section which upper end is in contact with the aluminum container.

The present invention is explained below in details according to a specific embodiment shown in the attached drawings. However, the present invention is not limited to this embodiment.

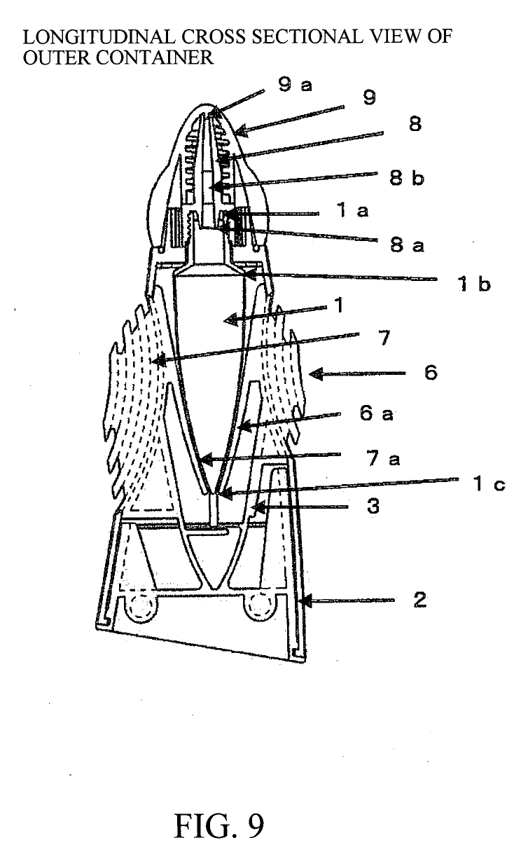

A composite container for an adhesive according to the present invention, as illustrated in FIG. 9, for example, includes: an aluminum container 1 which contains the adhesive; a resin outer container 2 which holds the aluminum container 1 and has two window holes; and a press component 3 which is provided with press sections 6 and 7 for indirectly pressing the aluminum container through the window holes provided on both side wall surfaces of the resin outer container 2, the press sections 6 and 7 being respectively provided with deformable plate-like springs 6a and 7a whose one ends are fixed to upper ends of the press sections 6 and 7 which upper ends are in contact with the aluminum container.

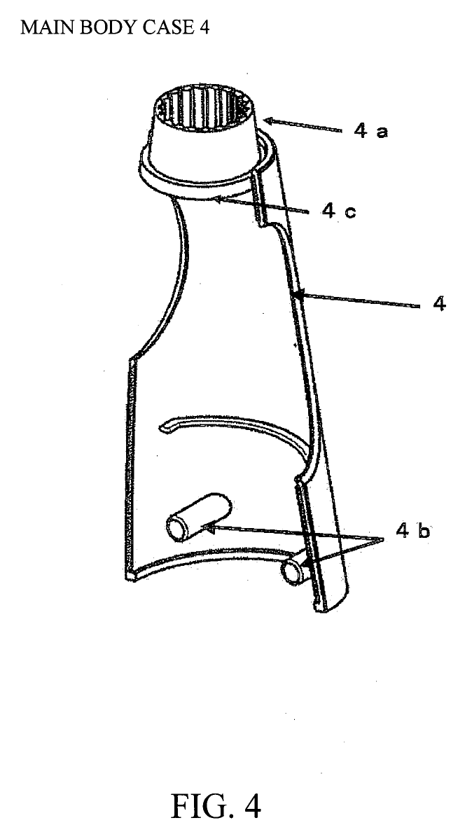

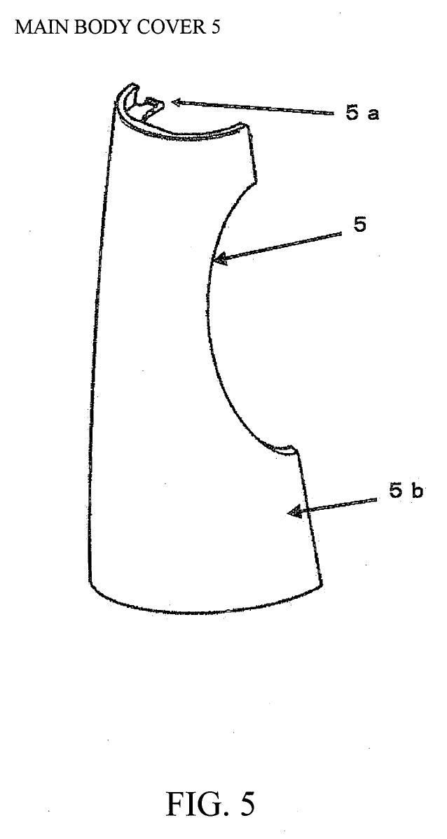

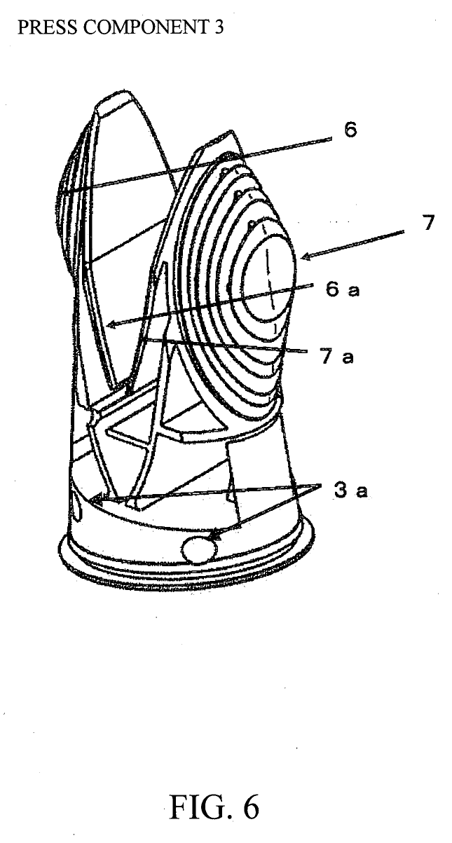

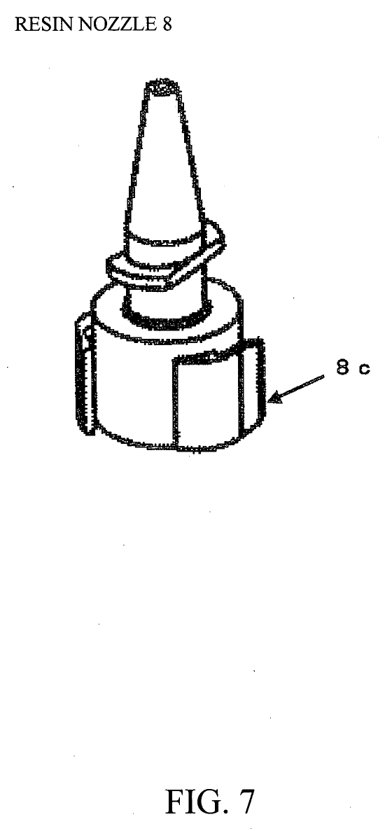

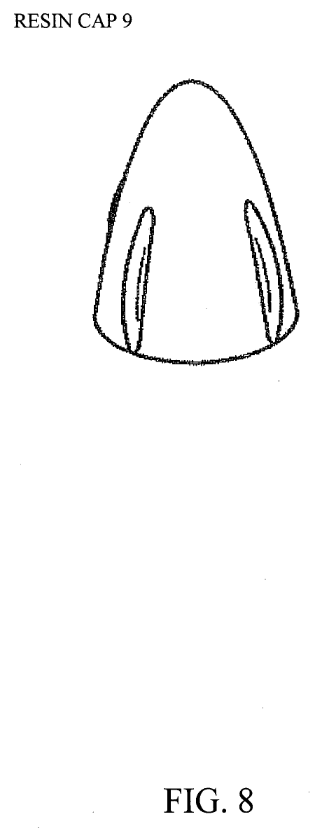

The resin outer container 2 supports the aluminum container 1 containing an adhesive and including an opening section 1a. The resin outer container 2 also includes a press component 3 (shown in FIG. 6), a resin main body case 4 (shown in FIG. 4), a resin main body cover 5 (shown in FIG. 5), a resin nozzle 8 (shown in FIG. 7), and a resin cap 9 (shown in FIG. 8). The press component 3 includes press sections 6 and 7 which indirectly press the aluminum container 1 through the window holes provided on both side wall surfaces of the resin outer container 2. The press sections 6 and 7 are respectively provided with deformable plate-like springs 6a and 7a whose one ends are fixed to upper ends of the press sections 6 and 7 which upper ends are in contact with the aluminum container 1. The resin main body case 4 is provided with window holes which allow the press sections 6 and 7 to protrude outside the resin outer container 2. The resin main body cover 5 is provided with window holes which allow the press sections 6 and 7 to protrude outside the outer container 2. The resin nozzle 8 is screwed on around the opening section 1a of the aluminum container 1. The resin cap 9 covers the resin nozzle 8.

This composite container for an adhesive is assembled as follows.

First, hold the aluminum container 1 on the resin main body case 4 and fit the press component 3 along the aluminum container 1. Secondly, attach the resin main body cover 5 to the resin main body case 4 so as to form a container and hold the aluminum container 1. Thirdly, fix the resin nozzle 8 around the opening section 1a of the aluminum container 1, and then attach the resin cap 9 as to cover the resin nozzle 8. Before first use of the adhesive in the aluminum container 1, screw the resin cap 9 together with the resin nozzle 8 to which the resin cap 9 is attached into a thin film sealing the adhesive contained in the aluminum container 1 so that the thin film is broken by a breaking section 8a. The aluminum container 1 is thus communicated with a discharge path 8b. When this communication between the aluminum container 1 and the discharge path 8b is obtained, screw the resin nozzle 8 on around the opening section 1a of the aluminum container 1.

Thereafter, the adhesive in the aluminum container 1 is used according to the following procedure: first, remove the resin cap 9; bring the resin nozzle 8 close to a spot where the adhesive is to be applied; and press one of or both of the press sections 6 and 7 illustrated in FIG. 6 and FIG. 9 so that the adhesive is discharged.

In order to cover the resin nozzle 8 with the use of the resin cap 9, reattach the resin cap 9 to the resin nozzle 8 so as to seal the resin nozzle 8 with a sealing section 9a. The adhesive is stored in the composite container having thus sealed resin nozzle 8.

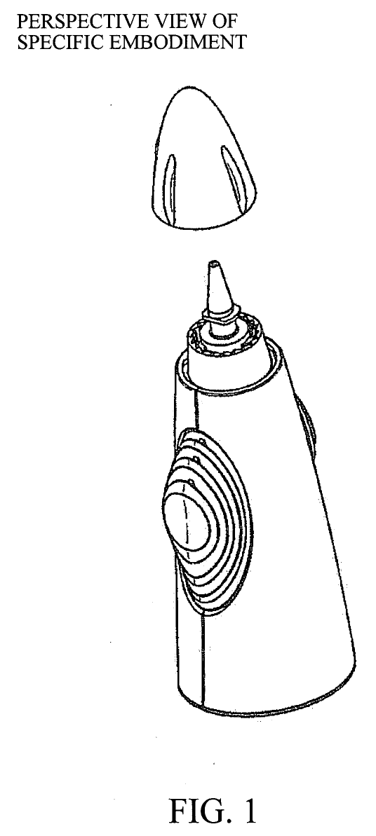

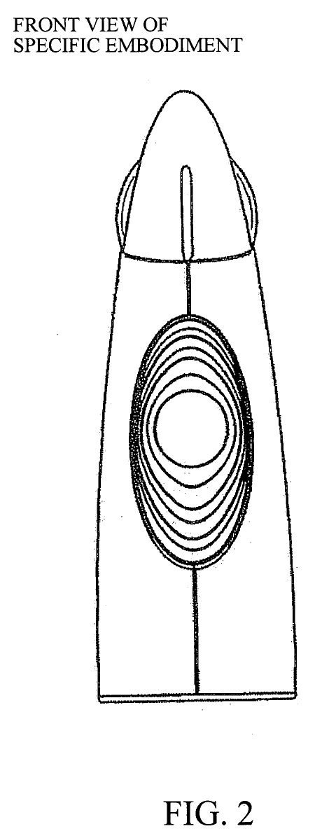

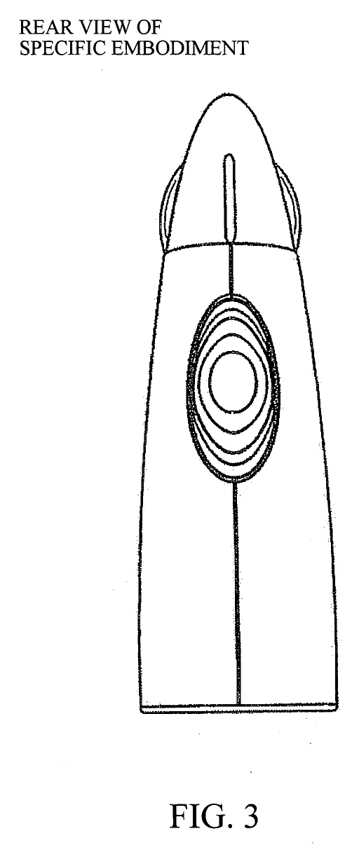

A shape of the resin outer container 2 is not specifically limited, if the resin outer container has a shape capable of holding the aluminum container 1. As illustrated in FIGS. 1 through 3, an example of the shape may be a conical shape having gently curved lines.

As illustrated in FIG. 4, the resin main body case 4 includes: two protrusions 4b which make it possible to attach and fix thereto the press component 3 including two press sections 6 and 7 respectively provided with deformable plate-like springs 6a and 7a whose one ends are fixed to the upper ends of the press sections 6 and 7 which upper ends are in contact with the aluminum container; an opening section 4c which is capable of holding the aluminum container 1; and a rachet structure 4a to which the resin nozzle 8 having a rachet structure 8c is engaged.

The resin main body cover 5, as shown in FIG. 5, includes: two protrusions 5b which make it possible to attach and fix thereto the press component 3 including two press sections 6 and 7 respectively provided with deformable plate-like springs 6a and 7a whose one ends are fixed to the upper ends of the press sections 6 and 7 which upper ends are in contact with the aluminum container 1; and a protrusion 5a which makes it possible to attach the resin main body cover 5 to the resin main body case 4.

The resin main body case 4 and the resin main body cover 5 each has a mirror surface structure. When assembled, the resin main body case 4 and the resin main body cover 5 form one smooth outer container.

The press component 3 includes: two depressed sections 3a that make it possible to fix the press component 3 to the resin main body case 4 and the resin main body case 5; and the press sections 6 and 7 respectively including plate-like springs 6a and 7a that make it possible to efficiently squeeze the adhesive out of the aluminum container 1.

The resin nozzle 8 is attached to the resin main body case 4 in which the aluminum container 1 is set. The resin nozzle 8 includes the rachet structure 8c which prevents the resin nozzle 8 from reverse turning that may detach the resin nozzle 8 when the resin cap 9 is removed for actual use of the adhesive in the aluminum container 1.

The resin nozzle 8 also includes the breaking section 8a for breaking the thin film sealing the opening section 1a of the aluminum container 1.

The resin cap 9 includes the sealing section 9a that can seal a top section of the resin nozzle 8 so that the adhesive is stored. Accordingly, the resin cap 9 can seal the top section of the resin nozzle 8 when turned in a direction opposite to a direction in which the resin cap 9 is turned at breakage of the sealed opening section of the aluminum container 1.

The above-mentioned components may be made of one material or different materials.

Next given is an explanation focusing on a substantial part of the present invention.

In the composite container for an adhesive, the press component 3 that makes it possible to indirectly press the aluminum container 1 is provided with the deformable plate-like springs 6a and 7a which directly press the aluminum container 1 and has respective ends fixed to upper ends of the press sections 6 and 7 which upper ends are in contact with the aluminum container 1. This makes it possible to press the aluminum container 1 in such a manner that a press is prioritized in a tail section of the aluminum container. As a result, it becomes possible to reduce an amount of the adhesive remaining in the aluminum container 1.

The composite container for an adhesive, in order to make it possible to precisely control a discharging amount of the adhesive, has at different heights the two press sections 6 and 7 which indirectly press the aluminum container 1 through the window holes provided on both side wall surfaces of the resin outer container 2 and are respectively provided with the deformable plate-like springs 6a and 7a whose one ends are fixed to the upper ends of the press sections 6 and 7 which upper ends are in contact with the aluminum container 1. In other words, height of a section protruding from the window hole provided on one side wall surface is arranged to be different from height of the other section protruding form the other window hole provided on the other side surface. This makes it possible to press the aluminum container 1 in a precisely controlled manner, which consequently makes it possible to precisely control a discharging amount of the adhesive.

As a result of studying a shape of the whole composite container the inventors of the present invention found out a composite container having a shape that fits snugly in a hand of a user and allows the user to easily perform a press action with his/her hand. One example of the composite container having such shape is illustrated in FIGS. 1 through 3, and 9 as an embodiment of the present invention.

This composite container can discharge other adhesives and various kinds of liquids. However, the composite container of the present invention is the most suitable as a container for a 2-cyanoacrylate adhesive, which is so-called an instant adhesive. 2-cyanoacrylate adhesives have viscosity varying in a broad range from a low viscosity adhesive to a gel adhesive.

The present invention is explained below in more details according to Examples.

(Aluminum Container Containing Instant Adhesive)

Each aluminum container containing an instant adhesive was prepared for testing by (i) filling an aluminum container, which has an inner diameter of 13 mm and a body length of 70 mm, with 5 grams of 2-cyanoacrylate instant adhesive whose viscosity was 100 mPa·s/20° C. or 50000 mPa·s/20° C. and (ii) sealing the aluminum container 1 by folding an unfolded open section of the aluminum container 1 to form the tail section.

Length of a folded part of the tail section can be adjusted. The tail section was folded as described in a following method of measuring according to Examples below.

(Method of Measuring Residual Ratio and Discharge Speed)

With respect to an amount of the adhesive remaining in the container, a residual ratio was measured. With respect to control of a discharging amount at a press, a discharge speed is measured as an indicator.

### 1. Prepare aluminum containers filled with 5.0 grams of a 2-cyanoacrylate instant adhesive having a viscosity of 100 mPa·s/20° C. and 5.0 grams of a 2-cyanoacrylate instant adhesive having a viscosity of 50000 mPa·s/20° C., respectively.

When the filling was completed, a length from a shoulder section of the aluminum container to the tail section thereof was approximately 48 mm.

2. Attach the thus prepared aluminum containers respectively to the composite container of the present invention, and composite containers which respectively have structures described in Japanese Design Registration No. 1096733 and Japanese Unexamined Patent Publication (Tokukai) No. 2004-182249, and measure weights (g) (A) of the composite containers to which the aluminum containers opened under a condition at a temperature of 20° C. were attached.
3. Under the condition at the temperature of 20° C., continuously press plural times each of the press sections of the composite containers with a finger until a limit is reached at which the press sections can no longer be depressed. Measure the time between the instant of an initial press and the instant when the adhesive is no longer discharged, and assume the measured time as a discharge time (s). At the point when the adhesive discharge stops, measure the weights (g) (B) of the composite containers holding the aluminum containers opened. Calculate their discharging amounts, their residual mounts, and their residual ratios according to following equations.

When discharge of the adhesive is completed, the length from the shoulder section of the aluminum container to the tail section thereof was approximately 44 mm.

4. At this time, a position where the plate-like spring came into contact with the aluminum container was approximately 40.5 mm below from the shoulder section of the aluminum container. The length from the position where the plate-like spring came contact with the aluminum container to the shoulder section was controlled so that the tail section was not pressed by the plate-like spring.

Discharging Amount (g)=(A)−(B)

Residual Amount (g)=5.0−Discharging Amount (g)

Residual Ratio (%)=(Residual Amount (g)/5.0)×100

Discharge Speed (g/s)=Discharging Amount (g)/Discharge Time (s)

### EXAMPLE 1

The aluminum container filled with 2-cyanoacrylate instant adhesive having viscosity of 100 mPa·s/20° C. was attached to the composite container for an adhesive of the present invention which composite container had the structure illustrated in FIGS. 1 through 9. Both of the two press sections 6 and 7 of such a composite container were pressed at the same time and a discharge testing was carried out. A result of this discharge testing is shown in Table 1.

### EXAMPLE 2

The aluminum container filled with 2-cyanoacrylate instant adhesive having viscosity of 50000 mPa·s/20° C. was attached to the composite container for an adhesive of the present invention which composite container had the structure illustrated in FIGS. 1 through 9. Both of the two press sections 6 and 7 of such a composite container were pressed at the same time and a discharge testing was carried out. A result of this discharge testing is shown in Table 2.

### COMPARATIVE EXAMPLE 1

The aluminum container filled with 2-cyanoacrylate instant adhesive having viscosity of 100 mPa·s/20° C. was attached to an outer container which had the structure described in Japanese Unexamined Patent Publication (Tokukai) No. 182249/2004. A press section of such an adhesive container was pressed and a discharge testing was carried out. A result of this discharge testing was shown in Table 1 as Comparative Example 1.

### COMPARATIVE EXAMPLE 2

The aluminum container filled with 2-cyanoacrylate instant adhesive having viscosity of 100 mPa·s/20° C. was attached to an outer container which had the structure described in Japanese Design Registration No. 1096733. Both of two press sections of such an outer container were pressed and a discharge testing was carried out. A result of this discharge testing is shown in Table 1 as Comparative Example 2.

### COMPARATIVE EXAMPLE 3

The aluminum container filled with 2-cyanoacrylate instant adhesive having viscosity of 50000 mPa·s/20° C. was attached to the outer container which had the structure described in Japanese Unexamined Patent Publication (Tokukai) No. 182249/2004. The press section of such an outer container was pressed and a discharge testing was carried out. A result of this discharge testing was shown in Table 2 as Comparative Example 3.

### COMPARATIVE EXAMPLE 4

The aluminum container filled with 2-cyanoacrylate instant adhesive having viscosity of 50000 mPa·s/20° C. was attached to the outer container which had the structure described in Japanese Design Registration No. 1096733. Both of the two press sections of such an outer container were pressed and a discharge testing was carried out. A result of this discharge testing was shown in Table 2 as Comparative Example 4.

### EXAMPLE 3

The aluminum container filled with 2-cyanoacrylate instant adhesive having viscosity of 100 mPa·s/20° C. was attached to the composite container for an adhesive of the present invention which had the structure illustrated in FIGS. 1 through 9. Only the press section 6 of such a composite container was pressed and a discharge speed was measured. A result of this measurement is shown in Table 3.

### EXAMPLE 4

The aluminum container filled with 2-cyanoacrylate instant adhesive having viscosity of 100 mPa·s/20° C. was attached to the composite container for an adhesive of the present invention which had the structure illustrated in FIGS. 1 through 9. Only the press section 7 of such a composite container was pressed and a discharge speed was measured. A result of this measurement is shown in Table 3.

### EXAMPLE 5

The aluminum container filled with 2-cyanoacrylate instant adhesive having viscosity of 100 mPa·s/20° C. was attached to the composite container for an adhesive of the present invention which had the structure illustrated in FIGS. 1 through 9. Both of the press sections 6 and 7 of such a composite container were pressed at the same time and a discharge speed was measured. A result of this measurement is shown in Table 3.

### EXAMPLE 6

The aluminum container filled with 2-cyanoacrylate instant adhesive having viscosity of 50000 mPa·s/20° C. was attached to the composite container for an adhesive of the present invention which had the structure illustrated in FIGS. 1 through 9. Only the press section 6 of such a composite container was pressed and a discharge testing was carried out. A result of this discharge testing is shown in Table 4.

### EXAMPLE 7

The aluminum container filled with 2-cyanoacrylate instant adhesive having viscosity of 50000 mPa·s/20° C. was attached to the composite container for an adhesive of the present invention which had the structure illustrated by FIGS. 1 through 9. Only the press section 7 of such a composite container was pressed and a discharge testing was carried out. A result of this discharge testing is shown in Table 4.

### EXAMPLE 8

The aluminum container filled with 2-cyanoacrylate instant adhesive having viscosity of 50000 mPa·s/20° C. was attached to the composite container for an adhesive of the present invention which had the structure illustrated by FIGS. 1 through 9. Both of the press sections 6 and 7 of such a composite container were pressed at the same time and a discharge testing was carried out. A result of this discharge testing is shown in Table 4.

TABLE 1

| | DIS- | | RESIDUAL RATIO (%) |
|---|---|---|---|
| | CHARGING | RESIDUAL | (RESIDUAL AMOUNT/ |
| | AMOUNT | AMOUNT | FILLING AMOUNT) × |
| | (G) | (G) | 100 |
| EXAMPLE 1 | 4.8 | 0.2 | 4 |
| COMPARATIVE | 4.7 | 0.3 | 6 |
| EXAMPLE 1 | | | |
| COMPARATIVE | 4.6 | 0.4 | 8 |
| EXAMPLE 2 | | | |

TABLE 2

| | DIS- | | RESIDUAL RATIO (%) |
|---|---|---|---|
| | CHARGING | RESIDUAL | (RESIDUAL AMOUNT/ |
| | AMOUNT | AMOUNT | FILLING AMOUNT) × |
| | (G) | (G) | 100 |
| EXAMPLE 2 | 4.3 | 0.7 | 14 |
| COMPARATIVE | 3.6 | 1.4 | 28 |
| EXAMPLE 3 | | | |
| COMPARATIVE | 3.4 | 1.6 | 32 |
| EXAMPLE 4 | | | |

TABLE 3

| | DISCHARGE | DISCHARGING |
|---|---|---|
| | SPEED | AMOUNT |
| | (G/S) | (G) |
| EXAMPLE 3 | 0.07 | 4.8 |
| EXAMPLE 4 | 0.10 | 4.8 |
| EXAMPLE 5 | 0.16 | 4.8 |

TABLE 4

| | DISCHARGE | DISCHARGING |
|---|---|---|
| | SPEED | AMOUNT |
| | (G/S) | (G) |
| EXAMPLE 6 | 0.01 | 2.8 |
| EXAMPLE 7 | 0.02 | 3.4 |
| EXAMPLE 8 | 0.05 | 4.3 |

As mentioned above, the composite container for an adhesive of the present invention is provided with deformable plate-like springs whose one ends are fixed to the upper ends of the press sections which upper ends are in contact with the aluminum container. This makes it possible to transmit just enough pressure to all sections of the aluminum container including a section close to an opening section of the aluminum container. Accordingly, it is possible to reduce, regardless of viscosity of the adhesive, an amount of the adhesive undischarged from the aluminum container containing the adhesive and remaining in the aluminum container.

It is preferable that the adhesive is a 2-cyanoacrylate adhesive.

The composite container for an adhesive of the present invention may be used for an adhesive such as a rubber adhesive, an epoxy resin adhesive, a polyurethane resin adhesive, a silicone adhesive, and a 2-cyanoacrylate adhesive. However, the composite container of the present invention is particularly suitable as a container for the 2-cyanoacrylate adhesive, which includes a composition varying in viscosity in a broad range from a low viscosity adhesive to a gel adhesive.

A composite container for an adhesive, according to the present invention, includes: an aluminum container which contains an adhesive; and a resin outer container holding the aluminum container, which resin outer container is provided with (a) window holes on both side wall surfaces and (b) two press sections for indirectly pressing the aluminum container through the window holes provided on the both side wall surfaces of the resin outer container, each of which press sections is provided with a deformable plate-like spring whose one end is fixed to an upper end of the press section which upper end is in contact with the aluminum container. If the composite container for an adhesive of the present invention is such a composite container, a shape of the composite container may be symmetric or asymmetric. However, it is preferable that the composite container has a shape that allows the user to easily hold the whole composite container and to easily press the composite container in a precisely controlled manner. For example it is preferable that the composite container has a shape as illustrated in FIGS. 1 through 3.

It is preferable that the plate-like springs of the present invention are molded of a thermoplastic resin such as polypropylene, polyethylene, and polyethylene terephthalate or a thermosetting resin such as polyurethane in a deformable shape.

According to the present invention, the ends of the plate-like springs are fixed to the upper ends of the two press sections which upper ends are in contact with the aluminum container. A method of fixing the ends of the plate-like springs is not specifically limited, if sufficient strength to press the aluminum container is obtained by the method. For example, the end of the plate-like spring may be partially or entirely fixed to the press section.

Similarly, a method of fixing the plate-like springs is not specifically limited if sufficient strength to press the aluminum container can be obtained by the method. Examples of the fixing method are a method of molding the press sections and the plate-like springs as one component, and a method of producing the press sections and the plate-like springs as separate components to fuse them together or bond them to each other.

According to the present invention, it is preferable that width of each plate-like spring is generally the same as width of the tail section of the aluminum container, or wider than the width of the tail section of the aluminum container.

In a case where the width of the plate-like spring is narrower than the width of the tail section of the aluminum container, an amount of the adhesive undischarged and remaining in the container tends to increase.

According to the present invention, length of the plate-like spring is generally adjusted so that the unfixed end section of the plate-like spring comes into contact with the aluminum container at a position a little higher than the tail section of the aluminum container. Length of a portion of the aluminum container where the adhesive is contained after adhesive discharge becomes shorter than the length thereof before the adhesive discharge. Accordingly, after the adhesive discharge, the unfixed end section which comes into contact with the aluminum container needs to be arranged in such a position that the plate-like spring presses the portion of the aluminum container where the adhesive is still contained. More specifically, assuming length from the shoulder section to the tail section of the aluminum container containing the adhesive is 100, the unfixed end section of the plate-like spring is preferably arranged at a position by a length of 1 to 30 higher than the tail section of the aluminum container. The unfixed end of the plate-like spring is more preferably arranged at a position by a length of 10 to 20 higher than the tail section of the aluminum container.

The composite container may have an arrangement in which the two press sections protruding outward from the resin outer container via the window holes are provided at different heights on the both wall side surfaces of the resin outer container.

In other words, as to the respective heights of the two press sections for indirectly pressing the aluminum container through the window holes provided on the both side wall surfaces of the resin outer container, each of which press sections is provided with a deformable plate-like spring whose one end is fixed to an upper end of the press section which upper end is in contact with the aluminum container, namely, as to the respective heights of the press sections protruding outward from the resin outer container through the window holes provided on the both side wall surfaces of the aluminum container, the heights may be the same as each other or different from each other. It is preferable that the heights are different from each other because the press sections provided at different heights make it possible to more precisely control a discharging amount of the adhesive.

It is preferable that the press section of the present invention is molded of a thermoplastic resin such as polypropylene, polyethylene, and polyethylene terephthalate or a thermosetting resin such as polyurethane in a restorable shape.

A part of the press sections which part directly contacts a hand may be made of soft resin, soft rubber, or the like in order to reduce stress on the hand.

According to the present invention, as mentioned above, the composite container for an adhesive is composed of an aluminum container containing an adhesive and a resin outer container holding the aluminum container. The composite container for an adhesive is provided with deformable press sections for indirectly pressing the aluminum container held in the resin outer container. The press sections are respectively large-sized and small-sized, and asymmetrically provided with respect to an axis of symmetry of the aluminum container. This makes it possible to press the aluminum container in a precisely controlled manner and precisely control a discharging amount of the adhesive.

As mentioned above, the press section for indirectly pressing the aluminum container is provided with a press part having a two-stage plate-like spring structure that directly presses the aluminum container. This makes it possible to press the aluminum container in such a manner that a press is prioritized in the tail section of the aluminum container. As a result, it becomes possible to reduce an amount of an adhesive remaining in the tail section.

The composite container of the present invention has a conical shape that fits in a hand holding the composite container. This prevents the container from slipping off the hand during work operation. Consequently, this reduces labor for the work operation.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A composite container for an adhesive comprising:
an aluminum container which contains an adhesive; and
a resin outer container for holding the aluminum container, the resin outer container being provided with (a) window holes on both side wall surfaces of the resin outer container and (b) two press sections for indirectly pressing the aluminum container through the window holes, each of the press sections being provided with a deformable plate-like spring whose one end is fixed to an upper end of the press section which upper end is in contact with the aluminum container.

2. The composite container for the adhesive as set forth in claim 1, wherein
the two press sections protruding outward from the resin outer container through the window holes are provided at different heights on the both side wall surfaces.

3. The composite container for the adhesive as set forth in claim 1, wherein
the adhesive is a 2-cyanoacrylate adhesive.
